(19) United States
(12) Patent Application Publication
(10) Pub. No.: US 2012/0260420 A1
(43) Pub. Date: Oct. 18, 2012

(54) BEDDING APPARATUS AND AN IMPROVED METHOD OF FORMING A BED

(76) Inventor: Mario Piraino, East Duncaster (AU)

(21) Appl. No.: 13/534,954

(22) Filed: Jun. 27, 2012

Related U.S. Application Data
(62) Division of application No. 11/583,631, filed on Oct. 18, 2006, now abandoned.
Application No. 11/583,631 is a continuation-in-part of application No. 10/344,336, filed on Jul. 10, 2003, now Pat. No. 7,159,255.

(30) Foreign Application Priority Data
Jun. 23, 2000 (AU) PQ 9614
Mar. 28, 2001 (AU) PR 4033

(51) Int. Cl. A47C 17/00; B23P 11/00; G06F 17/10; A47C 19/00

(52) U.S. Cl. 5/400; 5/690; 29/428; 703/2

(57) ABSTRACT

An improved method of forming a bed is provided. The method can include providing a bed mattress having at least a first area corresponding with a waist or lumbar of a user, a second area corresponding with hips of the user, and a third area corresponding with shoulders of a user. The method can also include providing a plurality of insertable structures having compression factors that are predetermined to provide a resiliency to each of the first, second, and third areas of the bed mattress, thereby allowing for a neutral sleeping position of the user.

### CROSS-REFERENCE TO RELATED APPLICATIONS

This is a continuation-in-part of and claims the benefit of priority from application Ser. No. 10/344,336, filed Feb. 11, 2003, entitled Improved Support Base for a Bed Mattress, and currently pending.

### FIELD OF THE INVENTION

This invention relates to a bedding apparatus and in particular to a method of forming an improved bed. More particularly the invention relates to an adjustable configuration of a bed.

### BACKGROUND

A bed ensemble is a combination of an upper mattress supported on a lower base and forms a typical bedding apparatus in common use as shown in FIG. 1. The upper mattress can be of any type, composition or configuration to provide the necessary comfort and primary or secondary support for the user. The base foundation is used to elevate the mattress off the ground and to provide ventilation, but importantly to also provide controlled support for the upper mattress.

Macro support is important to give the mattress the correct and optimal overall support to suit the user's physique and orthopaedic requirements.

The fine tuning or micro support of a bed is generally confined to the upper mattress which can be supplied in a range of hardness to suit the user. In addition, the upper mattress can be tailored to suit individual requirements with the provision of hybrid components to suit dual occupancy.

The correct and careful selection and adjustment of both the macro and micro support of a mattress is vital to achieve the optimal bedding support to suit the variety of user requirements which vary with the different physical and medical requirements of each individual.

To date, the ability of a bed base to provide adequate macro support has been limited by the crude systems available. Currently available base systems include innerspring bases and platform bases using transverse slats.

While innerspring bases give the user an impression of “comfort” by feeling soft, this system provides minimal controlled macro support and results in a “bouncy feel” rather than adequate overall support for an upper mattress.

Platform bases also provide macro support but have limited adjustment potential even with the incorporation of double slats and firmness adjusters which allow individual slats to be adjusted to provide various degrees of flex over the length of the slat. Such systems do little to provide the upper mattress with the necessary macro support to give the user's body optimal orthopaedic support. Double slats may provide variable flex giving rise to differential support but such slats only allow a deflection difference of up to about 15 mm over a standard slat when under load. Adult human bodies may have shape differences between the shoulders and waist of up to perhaps 80 mm. Accordingly, the potential deflection compensation available from double slats is quite insufficient to cater for such variations in the end user.

Furthermore, double slats do not provide an individual height adjustment for the slats but only an individual flex adjustment.

In order to provide a further level of macro adjustment, height adjustment of individual slats in a platform base would provide clear advantages. While some prior art devices are known which provide slating adjustment for bed bases incorporating individual transverse slats, none of the known prior art devices provide a ready means of adjusting individual slats in a quantitative and calibrated manner so as to allow the user or a medical adviser a satisfactory means of making suitable adjustment to confidently meet an individual's particular requirements.

If such individual height adjustment could be provided and could be operated external to the bed base, a means of ready and convenient alteration of a bed's macro support would be achieved.

Since people have unique body shapes and weight distribution along the length of their bodies, mattress and bed ensembles need some means of variable support along the length of the mattress. In particular the adjustment is required from the shoulder down to the waist, lower back, hip, under the knees and ultimately at the lower leg and feet.

Of prime importance is the correct support of a person in a bed, particularly if a person is in bed for a long period such as in the case of incapacitated people or patients in hospitals. It is well recognized throughout the health fraternity that ‘a person's bed plays a significant part in the person's health and well being’. Health experts tell us that for the human body to rest well, it needs to be supported in its natural shape. This natural/neutral posture imposes the least amount of stress on muscles, joints and the spinal/vertebral column. The user can get distortion from this position, stresses occur in muscles, nerves, joints and of course wedging occurs in the spinal disks.

A principal object of a bed mattress is to provide optimal support for the user commensurate with their physical and medical requirements. Such optimal support requires the mattress to conform substantially to the shape of the users body when resting on the mattress. Unfortunately, most available mattresses react proportionally to the weight distribution of the users body, compressing most where the body is heaviest and least where the body is lightest. This results in mattress conformation which does not reflect the actual physical shape of the users body, but rather reflects a shape imposed on the mattress by the weight distribution of the body. Accordingly, the users body adopts a shape, which results from the weight distribution of body segments, which does not reflect the actual body shape when resting on a standard mattress. The users skeleton is then twisted and distorted to fit the shape of the mattress as it has reacted to the users weight distribution.

The areas of greatest distortion are the shoulder and lumbar/hip regions. The shoulders are usually the widest part of the human body but occur at the lightest region of the torso. Accordingly the shoulders, when a user is resting on their side, do not push a mattress down much in accordance with the body shape resulting in a degree of twisting of the body when the user is sleeping on their side. In contrast to the shoulder and upper torso region, the hips and lumbar region of the torso are generally much heavier and this region of the users body will compress that part of a mattress disproportionately. In standard mattresses of uniform stiffness this results in the pelvis region being the lowest supported part of the body. Furthermore, the close proximity of the hip region to the waist region of the user tends to deprive the waist, and important lumbar region, of the user with adequate support as the mattress is highly compressed at the hip region and the adjoining area of the mattress leading into the lumbar region is also compressed where it should actually be providing support.

In order to provide optimal support a bed mattress should be able to react independently to the different regions of the users body and at least able to provide dedicated support for the upper, middle and lower torso regions, which all have quite distinct weight distribution and support requirements.

An analysis of these three regions designated Region “C” for upper torso; Region “B” for middle torso; and Region “P” for lower torso, highlights the different requirements needed to provide optimal support.

Given that the weight of the lower torso (pelvis region “P”) Wp is about 130% of the weight of the middle torso (Belly region “B”) Wb; and the weight of the upper torso (chest region “C”) We is about 50% of the weight of Wb. Then Wb=Wp/1.3=0.77 Wp Wc=0.5 Wb=0.39 Wp

If the mattress deflection at region B is minimal-say 15 mm and the lumbar curve of a users spine is about 60 mm then for a mattress of uniform stiffness or elasticity, deflection at region P and region C should be about 15+60 mm=75 mm. Such a deflection will require a spring stiffness Kb of (75/15)×[(1.0/1.3)×Kp]=385% Kp The spring stiffness Kc at region C should be (0.5/1.3)×Kp=39% Kp In summary, in order to provide optimal support over the region C, B and P the following general variation in firmness of the support material would be desirable.

| Upper | | Middle | | Lower | |
|---|---|---|---|---|---|
| Torso Kc | | Torso Kb | | Torso Kp | |
| 0.4 | Kp | 3.8 | Kp | | Kp |
| | Kc | 9.5 | Kc | 2.5 | Kc |
| 0.1 | Kb | | Kb | 0.26 | Kb |

Such variation in firmness of the support material is not usually available in production mattresses. The high cost of producing a mattress with such degrees of variation in stiffness plus the differing height of the end user necessitating different placement of regions C, B and P has prohibited the manufacture and availability of mattresses with such performance characteristics to date.

It is therefore an object of the invention to provide an improved support mattress and an improved mattress support base system for a bed that allows better specific support for a range of users of beds.

It is also an object of the invention to provide an improved support mattress and base system for a bed that overcomes or at least ameliorates the problems of the beds of the prior art.

### SUMMARY

In accordance with the invention there is provided a bed system having support means with at least one part formed with an elongated resilient means, the support means including at least two longitudinally related sections able to be affected by a selection of voids, solid shapes or resilient inserts to locally alter the resilience of the at least two longitudinally related sections for selectively adjusting the support means along its length.

Preferably the support means is altered by the selection of voids, solid shapes or resilient inserts to alter locally when in use the compression and the profile of the at least two longitudinally related sections according to a predetermined requirement of the user to allow for natural or neutral sleeping position of the user.

“Natural or neutral sleeping position of the user” means in this document a normal substantially neutral body position to allow substantially natural standing spine position.

In particular there are three predefined areas—a first corresponding with the waist or lumbar, a second corresponding with the hip, and a third corresponding with the shoulders; wherein the assessed determined related zone firmness of the three predefined longitudinally related areas sections are according to:

$${K}_{s} = \frac{{p}_{s}}{{D}_{w} + L + S}$$

$${K}_{w} = \frac{{p}_{w}}{{D}_{w }}$$

$$and$$

$${K}_{h} = \frac{{p}_{h }}{{D}_{w} + L}$$

With a vertical embedment at the waist=Dw, then the vertical displacement of the shoulder=Dw+L+S and=The total vertical displacement of the shoulder a) produced by the mattress+b) produced by the base.

The invention also provides a method of forming a bed system having a support base and a bed mattress which has at least two longitudinally related sections positioned to provide a waist & lumbar support and another of the at least two longitudinally related sections positioned to provide a shoulder support for the user of the bed with at least one planar portion able to compress relative to an adjacent planar portion with a planar flexible continuous mattress able to extend over both the planar portion and the adjacent planar portion including the steps of:
a. assessing a shape of a user;
b. determining required relative dimensions of at least a hip area and a shoulder area according to the assessed shape of the user;
c. assessing a determined related zone firmness of the at least two longitudinally related sections according to the determined required relative dimensions of at least a hip area and a shoulder area for the user to adjust the support means to provide a waist & lumbar support and shoulder support means for the user;
   wherein the support base allows for adjustment to a predetermined supporting formation relative to a proposed user with the predetermined compressible support means providing localized support.

In one aspect the invention provides a bed mattress including an outer casing adapted to house one or a plurality of different supportive materials within the casing in a distinct region wherein the outer casing provides for the ready insertion, removal and/or replacement of one or more of the supportive materials without dismantling the mattress or the casing so as to allow a user to vary the supportive quality of the distinct region of the mattress.

The distinct region or regions may be orientated transversely along the length of the mattress to correspond with the different regions of the users body. In such embodiments, the supportive materials may be inserted through a side wall of the mattress.

The supportive materials may be selected from any suitable products including inner spring segments, foam, latex, padding, rolled cotton, loose filling, water bladder sections etc.

The outer casing provides the necessary housing for assembling the selection of supportive materials and may be formed of foam or soft fabric, having side edges, top and bottom edges and a top and bottom face.

Ports in the outer casing may provide access to regions of the mattress to allow modification of the in situ supporting material to increase or decrease local areas of stiffness.

In another aspect the invention provides a bed mattress including an outer casing adapted to house one or a plurality of different supportive materials within the casing in distinct transverse regions wherein fixed supportive materials are provided at the top and bottom regions of the mattress corresponding to the head and foot regions of a user; and an intermediate region so formed between is provided with a transverse array of fixed supportive materials having vacant regions between adjacent materials, wherein the outer casing has a plurality of ports corresponding to the vacant regions which are adapted to facilitate the ready insertion, removal and/or replacement of one or more auxiliary supportive materials so as to allow the user to vary the supportive quality of the intermediate region of the mattress.

The array of fixed supporting means may be a bank of inner springs formed in transverse rows, although any suitable supportive materials can be used.

The intermediate zone may be bordered by a foam edge having slot openings or apertures corresponding to the vacant spaces between rows to receive the supportive materials which can be slid in between the rows to provide additional support to the intermediate zone.

The outer casing of the mattress may be provided with port openings on the side edges thereof corresponding to the intermediate zone.

In accordance with the invention there is provided a support base system for a bed mattress, the support base including a predetermined compressible support means for selectively adjusting a portion of the mattress relative to the longitudinal plane of extension of the adjacent remainder of the mattress.

The predetermined compressible support means can be used to selectively adjust a portion less than a quarter of the mattress. The predetermined compressible support means can be positioned so as to adjust an end portion of the mattress to provide a headrest or footrest for the user of the bed. However, in another form the predetermined compressible support means can be positioned so as to adjust a middle portion of the mattress to provide a lower lumbar support or a shoulder part or a knee support for the user of the bed.

The operation of the predetermined compressible support means in conjunction with the remainder of the bed mattress or support can use inserts or voids to provide adjusting a portion of the mattress or support relative to an adjacent remainder of the mattress or support.

Also in accordance with the invention there is provided a support base for a bed mattress having at least two longitudinally related portions of a mattress or support for the mattress is defined relative to one another, and the construction of the support base further including a predetermined compressible support means able to adjust a portion of the mattress out of the plane of longitudinal extension of the adjacent remainder of the mattress.

The predetermined compressible support means can be able to selectively adjust a portion less than a quarter of the mattress. A secondary predetermined compressible support means can be positioned so as to adjust an end portion of the mattress to provide a headrest or footrest for the user of the bed. However primarily the predetermined compressible support means can be positioned so as to adjust a middle portion of the mattress to provide a lower lumbar support or hip support for the user of the bed.

The invention also provides a support base for a bed mattress which can have at least two planar portions with at least one planar portion able to compress relative an adjacent planar portion with a planar flexible continuous mattress able to extend over both the planar portion and the adjacent planar portion, and the support base further including an predetermined compressible support means at least partially mounted on the planar portion and selectively able to adjust a portion of the mattress resting on the planar portion out of the plane of extension of the adjacent remainder of the mattress wherein the support base allows, for adjustment to a predetermined supporting formation relative to a proposed user with the predetermined compressible support means providing localized support.

Preferably there are three predefined areas—a first corresponding with the waist or lumbar, a second corresponding with the hip, and a third corresponding with the shoulders.

The support base for a bed mattress can further include a differential displacement member connected to the at least one planar portion, the differential displacement member engaging the predetermined compressible support means so as to displace the predetermined compressible support means towards the a portion of the mattress resting on the planar portion such that compression of the at least one planar portion relative to the another causes adjustment of the portion of the mattress out of the plane of extension of the adjacent remainder of the mattress.

The differential displacement member can be connected to the planar portion and engages a fixed means so as to displace the predetermined compressible support means towards the a portion of the mattress resting on the planar portion such that compression of the at least one planar portion relative to the another causes adjustment of the portion of the mattress out of the plane of extension of the adjacent remainder of the mattress.

The differential displacement member is in one form an elongated member connected to the planar portion and engaging a fixed means so as to extend at an differing angle to the compressible planar portion such that compression of the compressible planar portion causes a differential movement of the differential displacement member to the compressible planar portion to displace the predetermined compressible support means towards the a portion of the mattress resting on the planar portion such that compression of the at least one planar portion relative to the another causes adjustment of the portion of the mattress out of the plane of extension of the adjacent remainder of the mattress.

The invention can have a support base for a bed mattress including a housing having a plurality of transverse at least two longitudinally related portions of a mattress or support for the mattress for supporting the mattress wherein one or more of the at least two longitudinally related portions of a mattress or support for the mattress are individually adjustable relative to the housing to provide calibrated positive or negative height adjustment for each at least two longitudinally related portions of a mattress or support for the mattress, characterised in that the height adjustment is provided by at least one predetermined compressible support means.

The predetermined compressible support means, which can cause relative height adjustment, can be
(a) insertable structures having predetermined compression factor positioned at either end of a given at least two longitudinally related portions of a mattress or support for the mattress,
(b) structures having voids to allow ready compressibility of adjacent supporting material;
(c) elongate insertable structures having predetermined compression factor supporting the length of each at least two longitudinally related portions of a mattress or support for the mattress,
(d) general height adjusting blocks, or
(e) height adjusting blocks calibrated to a height adjustment scale shared by other means for height adjustment, such as insertable structures having predetermined compression factor.
(f) “humps and troughs-like shapes” that are insertable between the underside of the mattress and the foundation or base surface to impart a desired vertical displacement +ve or −ve as required.

If the elongate insertable structures having predetermined compression factor are made of suitable diameter the at least two longitudinally related portions of a mattress or support for the mattress can be eliminated with the bed mattress supported directly on the insertable structures having predetermined compression factor, which function as at least two longitudinally related portions of a mattress or support for the mattress.

Accordingly, in another aspect the invention provides a support base for a bed mattress including a housing having a plurality of transverse elongate insertable structures having predetermined compression factor for supporting the mattress and an adjustment means for the insertable structures having predetermined compression factor wherein one or more of the insertable structures having predetermined compression factor are individually adjusted relative to the housing to provide height calibrated adjustment for the bed mattress.

Preferably the height adjustment means is provided by a means, which is inserted external to the housing. In this way the bed can be modified to the specific dimensional requirements of the purchaser.

The insertable structures having predetermined compression factor may be colour coded to determine different compressible rates such that measurements pf a purchaser can be assimilated with the predefined compressible insert which can be inserted into the housing to provide the required relative longitudinal height adjustment. The insertable structures having predetermined compression factor may also be provided with calibrations to provide quantitative data on the amount of adjustment occurring. Handles or other fittings may be attached to the insertable height adjustment means.

The adjustment can be either totally individual from one height adjustment means to the next, or may be coordinated between height adjustment means to provide compound adjustment.

The height adjustment may be achieved by “general” height adjusting blocks or may be faithfully duplicated by the use of height adjusting blocks corresponding to the calibrations.

Preferably there are three major predefined areas—a first corresponding with the waist, a second corresponding with the hip depression of the lumbar (take out), and a third corresponding with the shoulders. The amount of height adjustment of the second or third zones is determined relative to the depression at the first zone.

With a vertical embedment at the waist=Dw, then the vertical displacement of the shoulder=Dw+L+S and=The total vertical displacement of the shoulder a) produced by the mattress+b) produced by the base.

The vertical + or −ve displacement could be produced by transverse object supported on blocks, or an object placed transversely and movable towards head or foot of bed and part of supporting bed base underneath or independent of that.

Support material varies in height +ve or −ve from hip to lumbar to shoulder such variations from support material of the same or different constitution blocks supporting transverse object, giving +ve or −ve displacement transverse material of varying height transverse member to full or half cross mattress made from a type material able to bear weight—different, similar or including materials used within the various comfort layers of a mattress.

The support base may be adapted for a range of bed sizes including single, double and larger sizes. The adjustment means can be coordinated for both sides of a multiple user bed or separate systems incorporated in either side.

In another aspect the invention provides a support base for a bed mattress wherein the support base housing has a hinged portion adapted for raising to support the user in a partially upright position wherein the raiseable portion of the housing incorporates one or more transverse at least two longitudinally related portions of a mattress or support for the mattress or transverse elongate insertable structures having predetermined compression factor for supporting the mattress wherein the at least two longitudinally related portions of a mattress or support for the mattress or insertable structures having predetermined compression factor are individually adjusted relative to the housing to provide local adjustment of the mattress wherein the adjustment is provided by a predetermined compressible support means providing relative height adjustment along the length of the bed.

### BRIEF DESCRIPTION OF THE DRAWINGS

In order that the invention is more readily understood embodiments of the invention will be described by way of illustration only with reference to the drawings wherein:

FIG. 1 is a diagrammatic view of a user of a bed system being supported in a natural or neutral sleeping position of the user;

FIG. 2 is a diagrammatic view of the components of a bed system;

FIG. 3 is a first form of structure for establishing a bed system in accordance with the invention for fulfilling the relative positioning of L and S of FIG. 1;

FIG. 4 is a first form of structure for establishing a bed system in accordance with the invention for fulfilling the relative positioning of L and S of FIG. 1;

FIG. 5 is a first form of structure for establishing a bed system in accordance with the invention for fulfilling the relative positioning of L and S of FIG. 1; and

FIGS. 6 and 7 show Tables 1A and 1B, which depict tables of relative positional measurements of L and S of FIG. 1 for a range of users in accordance with an embodiment of the invention.

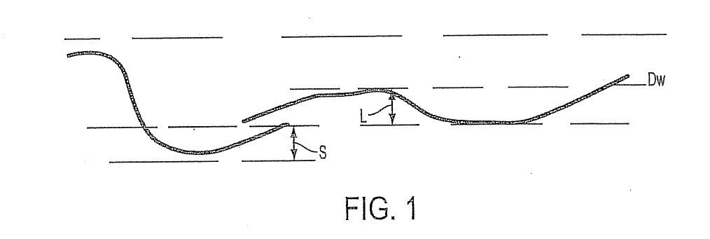

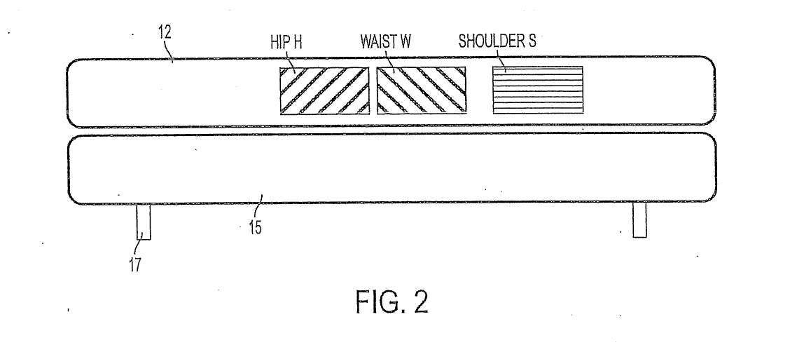

### DETAILED DESCRIPTION

In order to provide a mattress or bed base or combination, which can be considered as a ‘whole body support structure’ in one embodiment, it is necessary to calculate the requirements it needs to fulfil in order to minimize distortion of the body being supported. There are three predefined areas—a first corresponding with the waist and lumbar, a second corresponding with the hip, and a third corresponding with the shoulders.

The relative positions and distortions required for natural or neutral position can be designated as follows:
i) the depression of the mattress at the waist/lumbar (or the correction needed at this zone) as Dw, the weight of a unit area at that part of the body as Pw,
ii) the depression of the mattress at the shoulders (or the correction needed at this zone) as Ds, the weight of a unit area at that part of the body as Ps,
iii) the depression of the mattress at the hips (or the correction needed at this zone) Dh, the weight of a unit area at that part of the body as Ph,
iv) the width differential (extra to the waist) or the lumbar curve depth as L and the extra width of the shoulders to that as S
v) the stiffness/supportive ability of the mattress of a unit area at that part of the body as Ks (shoulder), Kw (waist/lumbar), and Kh hips).

Calculations have been carried out for such range of values as:
vi) L or lumbar curve=20, 35, 50, 65)
vii) Pw the weight/unit area at the Waist as being Double the weight that at the Shoulders and =(2*Ps), and the weight per unit area at the hips Ph as 2.5 times that at the shoulders=(2.5*Ps),
viii) The depression on the bed at the waist/lumbar: Dw as 1 to 30 mm, (calculate for Dw=to 1, 5, 10, 20, 30)
ix) the shoulders to be wider than the hips by S which can be from 0 to 100 mm (calculate for S=to 0, 25, 50, 75, 100)
x) it should be noted that for stomach sleepers, L refers to the vertical difference between the compressed stomach and upper thighs, ans S as the vertical difference between the compressed stomach and the outer part of the body (usually the chest).

Since the depression Dn of the bed at a point ‘n’ is given by the equation

Dn=Pn/Kn,conversely:Kn=Pn/Dn

(Where Pn is the weight supported by the bed at point ‘n’ and Kn is the effective firmness of the bed at point ‘n’)

Then the equation for firmness of the mattress at each of the 3 areas is:

$${K}_{s} = \frac{{p}_{s}}{{D}_{w} + L + S}$$

$${K}_{w} = \frac{{p}_{w}}{{D}_{w }} and$$

$${K}_{h} = \frac{{p}_{h}}{{D}_{w} + L}$$

$$So \frac{Ks}{Kh} = \frac{Ps}{( Dw + L + S )} \times \frac{( Dw + L )}{Ph} and$$

$$\frac{Kw}{Kh} = \frac{Pw}{Dw} \times \frac{( Dw + L )}{Ph}$$

$$or Ks = Kh \times \frac{( Dw + L )}{( Dw + L + S )} \times \frac{Ps}{Ph} \& Kh \times \frac{( Dw + L )}{Dw} \frac{Pw}{Ph}$$

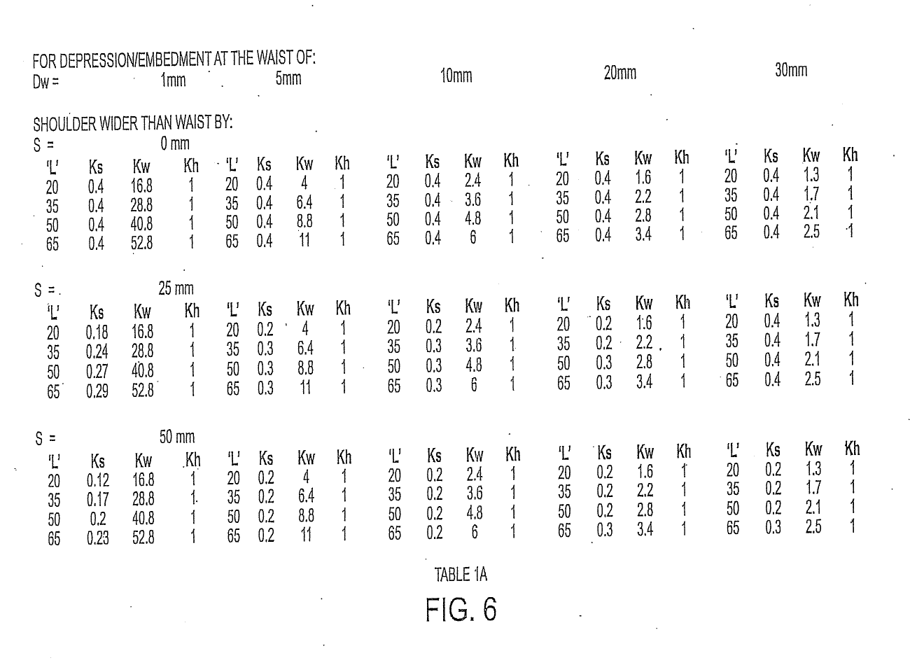

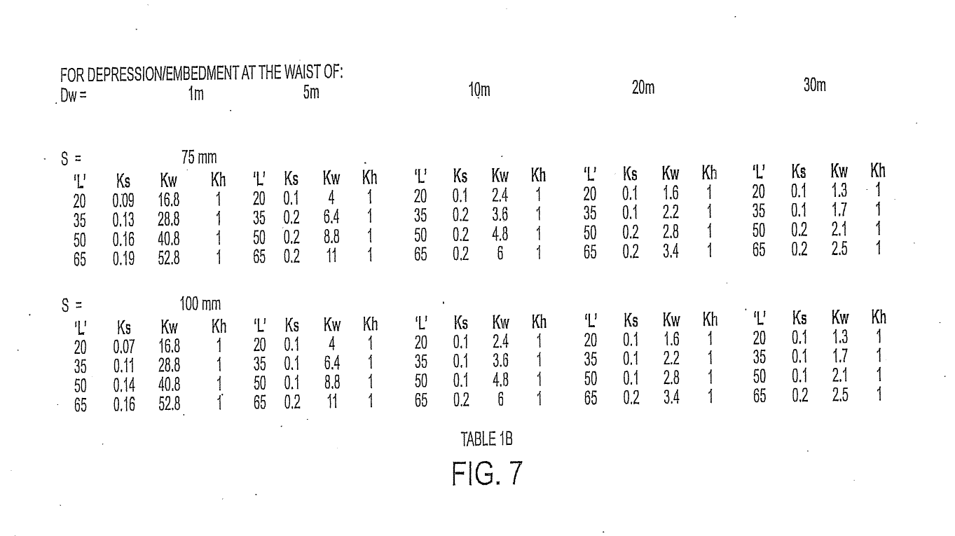

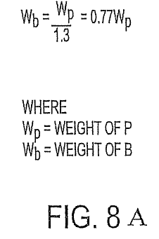

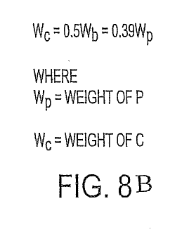

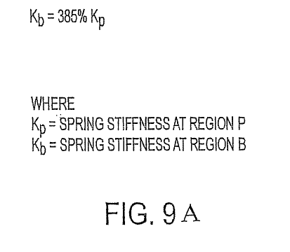

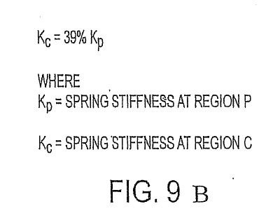

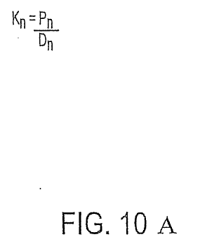

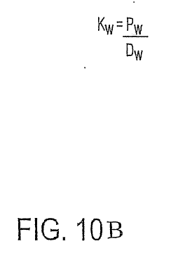

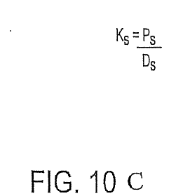

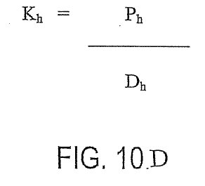

Tabulating values for these different combinations gives a picture of the values and inter-relationship between these factors. See Tables 1A and 1B of FIGS. 6-7, respectively.

For a male, one not-so-extreme situation would be:
Weight at stomach approx.=2*that at shoulders,
Weight at hips and upper thighs approx.=to weight at stomach
so Pw=2*Ps, Ph=Pw=2*Ps

| | |
|---|---|
| A Lumbar curve or hips wider than waist | 35 mm |
| of say: | |
| and shoulders wider than hips | 75 mm |
| TOTAL VARATION | 110 mm |

This body shape is very common with athletes and tradesmen

For a female, one not-so-extreme situation would be:
Weight at stomach approx.=2.0*that at shoulders,
Weight at hips and upper thighs approx. 15% extra to weight at stomach
so Pw=2*Ps, Ph=1.15*Pw=2.3*Ps

| | |
|---|---|
| A Lumbar curve or hips wider than waist | 65 mm |
| of say: | |
| and shoulders wider than hips | −15 mm |
| TOTAL VARATION | 50 mm |

Here are 3 examples of how to shape the bed for each (male and female) on their own or on each respective side of the bed if they were a couple:

Example Bed 1. (Corrective Shaping is Affected Fully within the Mattress)
The mattress for each is made with a hybrid of varying firmnesses along the bed such that the depression at the 3 key points are appropriate for each.
i) for the male, for a mattress on which the Dw (depression at waist)=20 mm,

Ks,m=Kh×(20+35)/(20+35+75)×1/2=0.21*Kh

and Kw,m=Kh×(20+35)/20×1/1=2.75*Kh
ii) for the female, for a mattress on which the Dw (depression at waist)=20 mm,

Ks=Kh×(20+65)/(20+65−15)×1/2.3=0.53*Kh

Kw=Kh×(20+65)/(20)×1/1.15=3.70*Kh
The mattress is manufactured with the 3 important zones at theses calculated values and the areas in between are blended to smoothen the curves produced at the shoulders to waist to hips.
   Example Bed 2. (Corrective Shaping is Affected Fully from Means Under the Mattress)

The mattress is entirely of uniform firmness for both the Male and the Female.

i) The Male compresses the mattress by 40 mm at the waist and therefore only 40/2=20 mm at the shoulders (Ps=1/2 Pw) which are now 20 mm above the waist instead of 110 mm below, and compresses the mattress also 40 mm at the Hips (Ph=Pw) which should be 35 mm below the waist—so the base system (using blocks or some other means) or ‘hump and through system’ under the bottom surface of the mattress has to correct the vertical displacement the mattress top surface by
a) −ve 10 mm at the hips, (now −40−10=−50 mm)
b) +ve 25 mm at waist, (now −40+25=−15 mm) net compression at waist, and (25+10=35 mm above hips which is correct)
c) −ve 105 mm at the shoulders so they are (−20-105−(−40)+25=−110 mm below waist)
   ii) The female also happens to compresses the mattress at the waist by 40 mm but (because of her weight) only 40/2=20 mm at the shoulders, and 40*1.15=46 mm at the hips—so the base system (using blocks or some other means) or ‘hump and through system’ under the bottom surface of the mattress has to correct the vertical displacement the mattress top surface by
a) +ve 24 mm at the waist (this is now a nett −40+24=−16 mm depression at the waist)
b) −ve 35 mm at the hips (this is now 6+24+35=65 mm below the waist)
c) −ve 46 mm at the shoulders (this is now −20+16−(−40)+24=−50 mm below the waist)
   Example Bed 3. (corrective shaping is affected fully by a hybrid of means: from i) within the mattress, ii) underneath the bottom surface of the mattress but above the top surface of the base, and iii) by shaping of the top surface of the base means under the mattress)

The user can use a full combination of Zoning (shaping) within the mattress and applying the net applicable corrections by the mattress supportive system.

Using a zoned mattress with voids and other predetermined compressible support means such that its properties from Table 3 are—as follows:

Dw=20 mm, L=35, Ks=0.2, Kw=2.2, S=25 mm. (for Pw=2Ps and Ph=2.5Ps)

Then:
i) The Male compresses the Mattresses at the waist by 20 mm,
L=35*(2/2.5)=28 mm, so hips are 28 mm below the waist and
S 25 mm so the shoulders are 25 mm below the waist
   So the—base system (using blocks or some other means) or ‘hump and through system’ under the bottom surface of the mattress is able to correct the vertical displacement the mattress top surface as follows:
a) place a +ve 25 mm shape (flat in this case) from below the shoulder area to the feet, this means that the shoulders are now −25−25=−50 mm below the waist
b) −ve 7 mm vertical displacement of the hips (−28−7=−35 mm) which aligns the hips correctly with the waist.
c) −ve 60 mm vertical displacement at the shoulder area so shoulders are aligned,
ii) The Female compresses the Mattresses at the waist by 20 mm,
L=35*(1.15*2/2.5)=32 mm, so hips are 32 mm below the waist and
S 25 mm so the shoulders are 25 mm below the waist

So the—base system (using blocks or some other means) or ‘hump and through system’ under the bottom surface of the mattress has to correct the vertical displacement the mattress top surface by
a) place a +ve 25 mm shape (flat in this case) from below the shoulder area to the feet, this means that the shoulders are now −25−25=−50 mm below the waist which is correct,
b) —depress the hip area only by the base supportive surface by −ve 33 mm this now makes the hips (−33−32=)−65 mm below the waist—which is correct

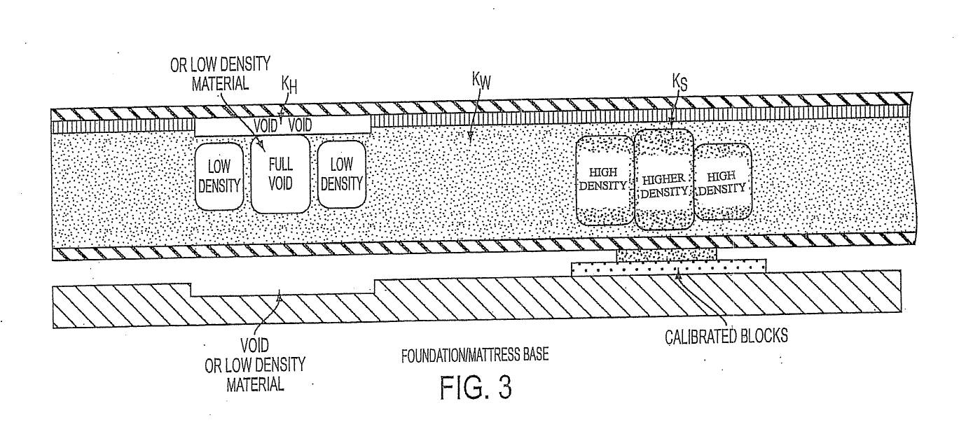

Referring to FIGS. 3 to 5 there is shown three forms of structure that allow for selection of voids, solid shapes or resilient inserts to alter locally when in use the compression and the profile of the at least two longitudinally related sections according to a predetermined requirement of the user to allow for natural or neutral sleeping position of the user.

In FIG. 3 there is a mattress and a base. The stiffness/supportive ability of the mattress of a unit area at that part of the body as Ks (shoulder), Kw (waist/lumbar), and Kh hips) is provided by a combination of base and mattress. In the base there can be located voids to allow the mattress to sink into the base. Further there can be calibrated blocks to allow upward distortion of the mattress. Further in the mattress are linear top-level voids in the top layer of the mattress and overlying deep voids or low-density material sections.

The combination at the hips in a longitudinal direction of the top layer void, deep internal void or low density void of the mattress and the void in the base allow the sufficient variation of depression with required compression relative to other sections to accommodate the persons differing weight along the length of the bed. The section though is particularly shaped due to the variation at each section such as shaping or full void alongside low-density material.

At the shoulder area are a range of differing sized, shaped and variable high density material in the mattress overlying shaped calibrated blocks in the base to provide differing shaped support of the shoulders compared to the waist and hips.

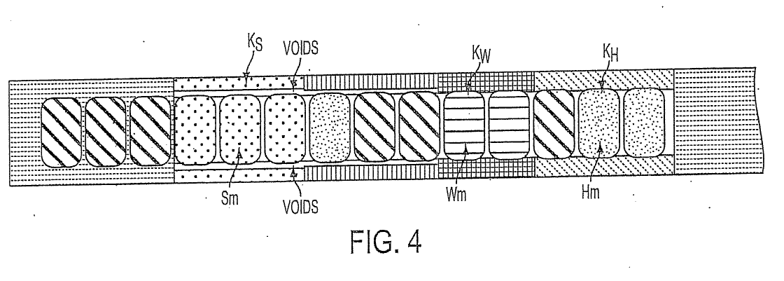

In FIG. 4 there is a bedding with differing top layers and in each section multiple central sections. The stiffness/supportive ability of the bedding at each part of the body defined as Ks (shoulder), Kw (waist/lumbar), and Kh hips) is provided by Sm support comprising light supportive materials in shoulder area with a series of shaped voids and softer padding layers to decrease firmness and allow more compression thus making way for shoulder to fit in deeper into supportive shaped. At the waist to provide Kw there is Wm comprising firmest supportive material plus thicker and firmer padding layers to cause more firmness and less depression at the waist. At the hip there is Hm to provide Kh comprising medium firmness support, materials and padding layers with/without use of voids in order to allow the hips to depress into the mattress b the desired amount.

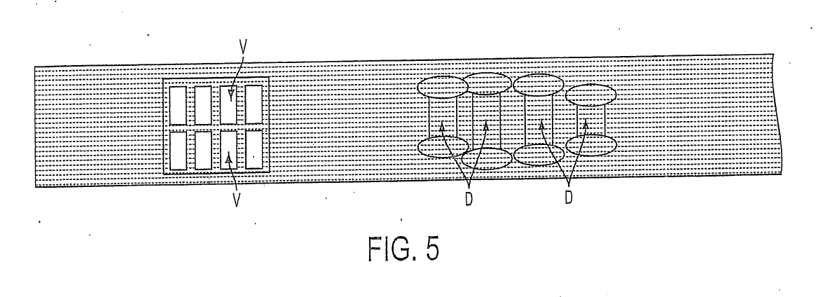

In FIG. 5 there is a latex or core bedding which is able to have varying voids V alongside each other and above each other in one section with the voids able to receive various density foam or other material inserted therein to change the compression and depression of that section of he bedding. At another section can be chambers for receiving dumbbell shaped firmer density materials with varying heights placed within the core or latex bedding. The dumbbell shape controls the variation of compression while altering the depression in a shaped manner.

It should be understood that the above description is of preferred embodiments and included as illustration only. It is not limiting of the invention. Clearly variations of the method of forming a bed system would be understood by a person skilled in the art without any inventiveness and such variations are included within the scope of this invention as defined in the following claims.

1-20. (canceled)

21. A method comprising:
providing a bed mattress having at least a first area corresponding with a waist or lumbar of a user, a second area corresponding with hips of the user, and a third area corresponding with shoulders of the user; and
providing a plurality of insertable structures having compression factors that are predetermined to provide a resiliency to each of the first, second, and third areas of the bed mattress, thereby allowing for a neutral sleeping position of the user.

22. The method of claim 21 further comprising calculating a target resiliency for each of the first, second and third areas of the bed mattress.

23. The method of claim 22 wherein the target resiliencies are calculated based on measurements taken from a specific user.

24. The method of claim 22 further comprising:
calculating the target resiliency for the first area of the bed mattress corresponding to the waist or lumbar as Kw=Pw/Dw;
calculating the target resiliency for the second area of the bed mattress corresponding to the hips as Kh=Ph/(Dw+L); and
calculating the target resiliency for the third area of the bed mattress corresponding to the shoulders as Ks=Ps/(Dw+L+S),
wherein Ps is a weight of the shoulders of the user's body, Pw is a weight of the waist or lumbar of the user's body, Ph is a weight of the hips of the user's body, Dw is a depression of the bed mattress in the first area corresponding to the waist or lumbar, L is a width differential between hips and the waist of the user and S is a width differential between the shoulders and the waist of the user.

25. The method of claim 21 further comprising inserting the plurality of insertable structures into a portion of the bed mattress.

26. The method of claim 21 wherein each of the plurality of insertable structures is provided pre-inserted in the bed mattress.

27. The method of claim 21 further comprising providing a support base for the bed mattress.

28. The method of claim 27 further comprising inserting each of the plurality of insertable structures into a portion of the support base.

29. The method of claim 27 wherein each of the plurality of insertable structures is provided pre-inserted in the support base.

30. The method of claim 21 wherein each of the plurality of insertable structures is individually selected from a group consisting of: structures having voids, solid shapes, resilient inserts, calibrated blocks, and dumbbell shaped firmer density materials.
